(19) United States
(12) Patent Application Publication
(10) Pub. No.: US 2026/0121329 A1
(43) Pub. Date: Apr. 30, 2026

(54) ELECTRICAL CONNECTOR

(71) Applicant: Tyco Electronics (Shanghai) Co., Ltd., Shanghai (CN)

(72) Inventors: Hengkang Wu, Dongguan (CN); David (Xinjie) Zhang, Shanghai (CN)

(73) Assignee: Tyco Electronics (Shanghai) Co., Ltd., Shanghai (CN)

(21) Appl. No.: 19/318,799

(22) Filed: Sep. 4, 2025

(30) Foreign Application Priority Data
Sep. 6, 2024 (CN) 202411252640.1

(51) Int. Cl. H01R 13/42; H01R 13/506; H01R 13/6598; H01R 24/28

(52) U.S. Cl. CPC H01R 13/42; H01R 13/506; H01R 13/6598; H01R 24/28

(57) ABSTRACT

An electrical connector includes a housing, a pair of terminal assemblies, and a grounding member. Each of the terminal assemblies includes at least one set of conductive terminals extending parallel to a longitudinal direction of the housing, at least one cable, and a mounting base. Each set of conductive terminals has a pair of signal terminals and a pair of ground terminals. Each cable has a pair of signal conductors respectively conductively connected to the signal terminals in a respective set of conductive terminals. The at least one set of conductive terminals passes through the mounting base and is divided by the mounting base into a mounting segment on a side facing the at least one cable and a free end on an opposite side. The grounding member is conductively connected to respective ground terminals of one terminal assembly and integrally covers respective signal terminals of the one terminal assembly.

### CROSS-REFERENCE TO RELATED APPLICATION

This application claims the benefit of the filing date under 35 U.S.C. § 119 (a)-(d) of Chinese Patent Application No. 202411252640.1, filed on Sep. 6, 2024.

### FIELD OF THE INVENTION

The present disclosure relates to an electrical connector, and more specifically, to an electrical connector capable of optimizing isolation of interference between signals and having improved signal integrity against crosstalk, applicable in, for example, but not limited to, the field of data communication, suitable for different application requirements, such as high-speed data transmission applications.

### BACKGROUND OF THE INVENTION

Electrical connectors are electronic components for transmitting and exchanging current or signals between electronic system devices. Serving as nodes, electrical connectors independently or together with cables transmit current or signals between devices, components, equipment, and systems, and maintain changes in signal distortion and energy loss between systems, and are essential basic components constituting the connection of the entire system. For example, I/O modules are typically used for connections between switches, and between switches and servers.

In the field of data communication, connector assemblies are typically employed to achieve signal transmission between two printed circuit boards (PCBs); specifically, as a typical example, the connector assembly mainly includes two connectors mating with each other, the two connectors being respectively mounted on the two printed circuit boards, and then by mating the two connectors together, signal transmission between the two printed circuit boards is achieved. Existing electrical connectors typically include an insulating housing (such as a plastic housing) and contact conductive terminals (including signal terminals and ground terminals) assembled in the insulating housing. Through these conductive terminals of the two electrical connectors assembled in the same electrical connector assembly, physical interconnection and electrical connection between the two circuit boards are achieved.

With the continuous increase in data rates and data volume of high-speed links, extremely high requirements are placed on connector performance. The SI (Signal Integrity) performance of existing high-speed connectors can only meet PCIe Gen5 performance requirements and cannot adequately meet the SI performance requirements of the next-generation PCIe Gen6. Therefore, there is an urgent need for an improved electrical connector, which, for example, by providing mutually cooperating shielding structures on a grounding member, can achieve an increased coverage area of the shielding region (e.g., the shielding region extending to the mating interface and/or the location where the cable is stripped to expose the metal shield layer), thereby significantly improving signal integrity (especially against near-end crosstalk and far-end crosstalk), thus effectively isolating interference between signals. Moreover, the design of such shielding structures can be further aimed at applying to next-generation DLF platform designs.

### SUMMARY OF THE INVENTION

An electrical connector includes a housing, a pair of terminal assemblies, and a grounding member. Each of the terminal assemblies includes at least one set of conductive terminals extending parallel to a longitudinal direction of the housing, at least one cable, and a mounting base. Each set of conductive terminals has a pair of signal terminals and a pair of ground terminals. Each cable has a pair of signal conductors respectively conductively connected to the signal terminals in a respective set of conductive terminals. The at least one set of conductive terminals passes through the mounting base and is divided by the mounting base into a mounting segment on a side facing the at least one cable and a free end on an opposite side. The grounding member is conductively connected to respective ground terminals of one terminal assembly and integrally covers respective signal terminals of the one terminal assembly.

### BRIEF DESCRIPTION OF THE DRAWINGS

The accompanying drawings, which are incorporated in and constitute a portion of the specification, illustrate certain aspects of the subject matter disclosed herein and, together with the description, facilitate interpreting some principles associated with the embodiments as disclosed. In the attached drawings:

FIG. 1A is a perspective view of an electrical connector according to an embodiment in an assembled state;

FIG. 1B is another perspective view of the electrical connector in the assembled state;

FIG. 1C is a partially exploded perspective view of the electrical connector;

FIG. 1D is another partially exploded perspective view of the electrical connector;

FIG. 2A is a perspective view of a grounding member according to an embodiment;

FIG. 2B is a front view of the grounding member;

FIG. 2C is a rear view of the grounding member;

FIG. 2D is a top view of the grounding member;

FIG. 2E is a bottom view of the grounding member;

FIG. 2F is a left side view of the grounding member;

FIG. 2G is a right side view of the grounding member;

FIG. 3A is a perspective view of the electrical connector with a housing removed;

FIG. 3B is a left side view of the electrical connector with the housing removed;

FIG. 3C is a perspective view of the electrical connector with upper and lower internal components in a separated state;

FIG. 4A is a top view of upper and lower internal components in a separated state with a fixing member and mounting bases removed;

FIG. 4B is a bottom view of the upper and lower internal components in the separated state with the fixing member and the mounting bases removed;

FIG. 5A is a perspective view of an upper internal component with a fixing part of the fixing member and the mounting base removed;

FIG. 5B is another perspective view of the upper internal component with the fixing part and the mounting base removed;

FIG. 5C is a perspective view of a lower internal component with the fixing part and the mounting base removed;

FIG. 5D is another perspective view of the lower internal component with the fixing part and the mounting base removed;

FIG. 6A is a left side view of the internal components in an assembled state with the fixing member removed;

FIG. 6B is a perspective view of upper and lower internal components in a separated state with the fixing member removed; and

FIG. 7 is a perspective view of the fixing member within the internal components, with a pair of fixing parts in a separated state.

### DETAILED DESCRIPTION

The present disclosure will now be described in detail with reference to the drawings, which are provided as illustrative examples of the present disclosure to enable those skilled in the art to practice the disclosure. It is to be noted that the following drawings and examples are not intended to limit the scope of the disclosure to a single embodiment, but other embodiments are possible by interchange of some or all of the described or illustrated elements. Moreover, where known components may be used partially or entirely to implement elements of the present disclosure, only those parts of such known components necessary for understanding the present disclosure will be described, and detailed descriptions of other parts of such known components will be omitted so as not to obscure the present disclosure.

Unless otherwise specified herein, as will be understood by those skilled in the art, embodiments described as implemented in software should not be limited as such, but may include embodiments implemented in hardware or a combination of software and hardware, and vice versa. In this specification, embodiments showing a singular component should not be considered limiting; rather, unless explicitly stated otherwise herein, the present disclosure is intended to cover other embodiments including a plurality of the same components, and vice versa. Furthermore, the applicant does not intend that any term in the specification or claims be ascribed an uncommon or special meaning unless explicitly stated as such. Additionally, the present disclosure encompasses present and future known equivalents of the known components referred to herein by way of illustration.

Unless otherwise specified, “bottom” and “top”, “upper” and “lower”, etc., appearing in the content recorded in the present disclosure are relative concepts. And “respective” appearing in the content recorded in the present disclosure refers to the correspondence between components that are used in pairs and work cooperatively.

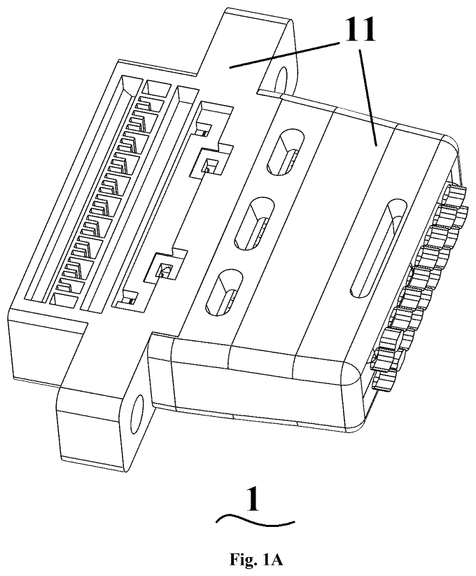

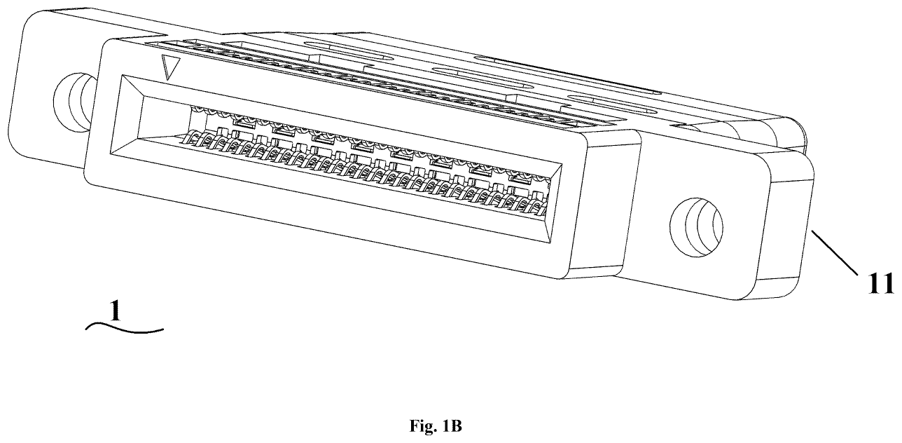

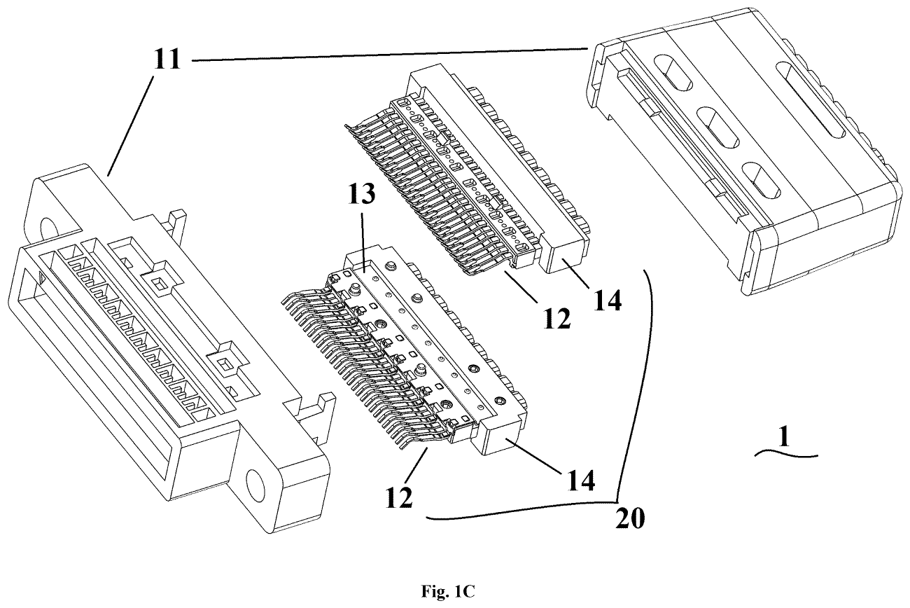

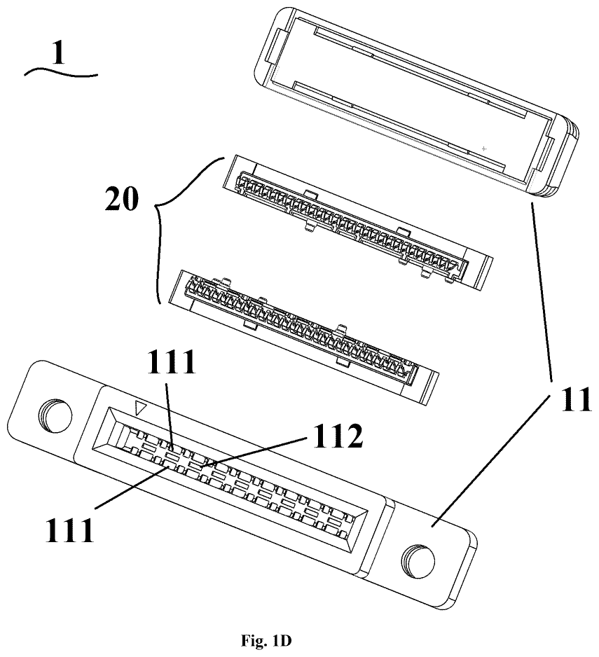

According to a general technical concept of the present disclosure, for example as shown in FIGS. 1A to ID, an electrical connector 1 is provided, comprising: a housing 11, for example including a front housing and a rear housing that cooperate with each other to define an internal cavity; and internal components 20 disposed within the housing 11, the internal components 20 for example including two terminal assemblies 12, adjacent and juxtaposed within the internal cavity of the housing 11, each terminal assembly 12 comprising: at least one set of conductive terminals 120, extending parallel to a longitudinal direction of the housing 11, each set of conductive terminals 120 comprising a pair of signal terminals 121 and a pair of ground terminals 122; at least one cable 124, each cable 124 comprising a pair of signal conductors 1241 respectively conductively connected to the signal terminals 121 in a respective set of conductive terminals 120; and a mounting base 120c, the at least one set of conductive terminals 120 passing through the mounting base 120c and being divided by the mounting base 120c into a mounting segment 120b on a side facing the at least one cable 124 and a free end 120a on an opposite side. For example, the free end 120a of each conductive terminal 120 serves as a contact segment configured to be in conductive contact with connection terminals of a mating connector. The internal components 20 of the electrical connector 1 further comprise, for example, a grounding member 13, the grounding member 13 being located between the two terminal assemblies 12 and conductively connected to respective ground terminals 122 of one terminal assembly 12, and integrally covering respective signal terminals 121 of the one terminal assembly 12.

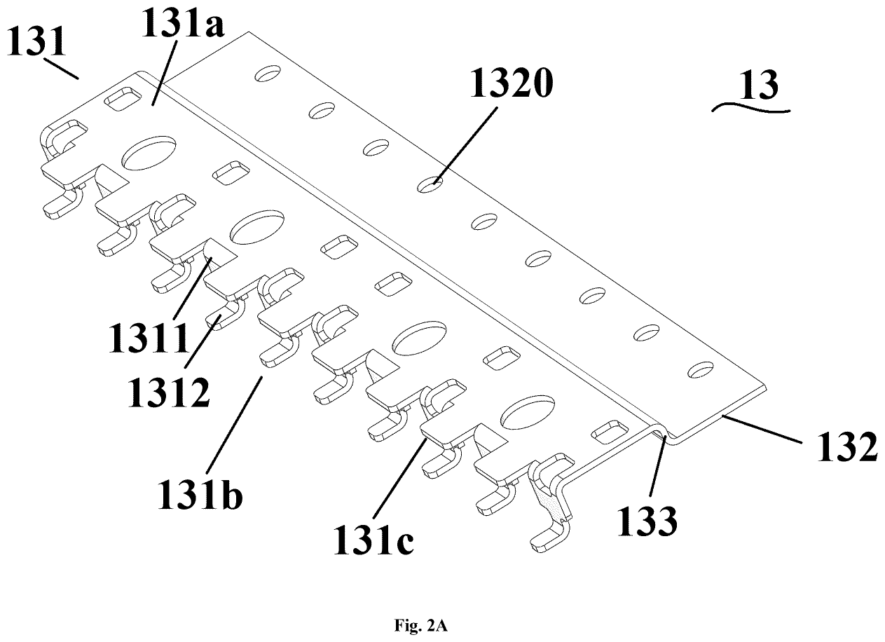

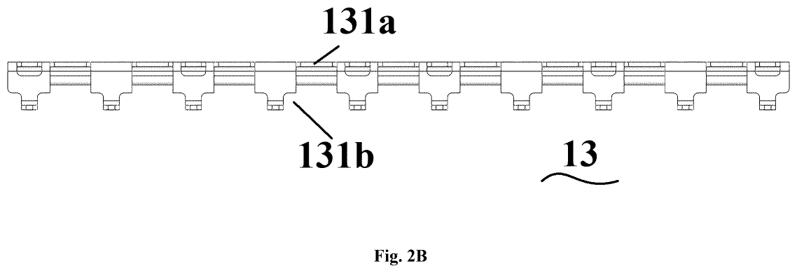

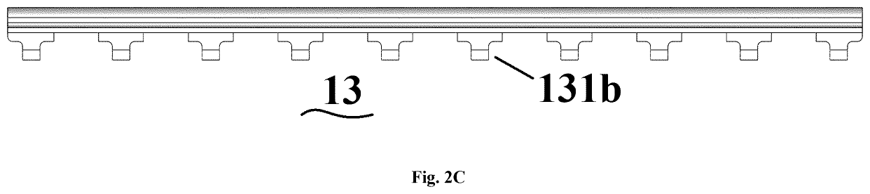

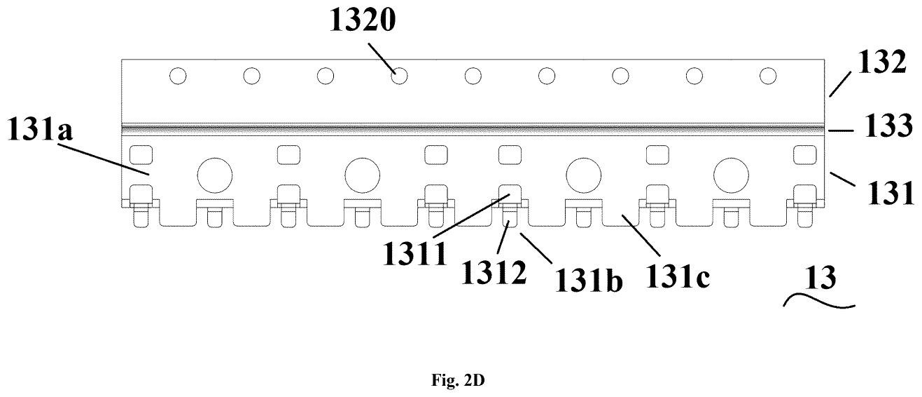

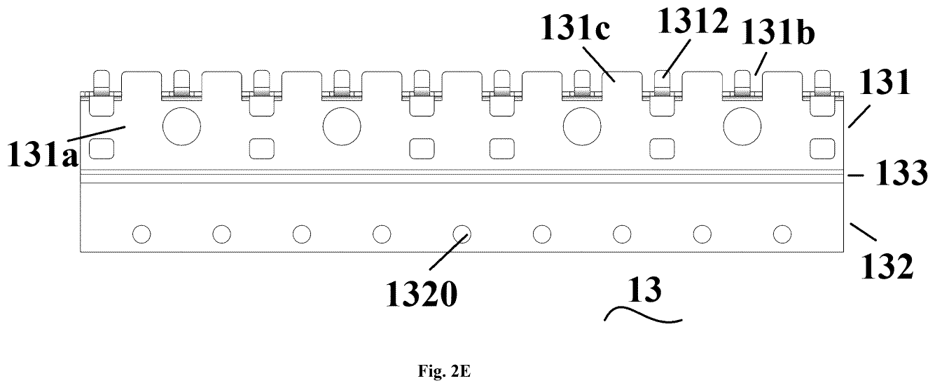

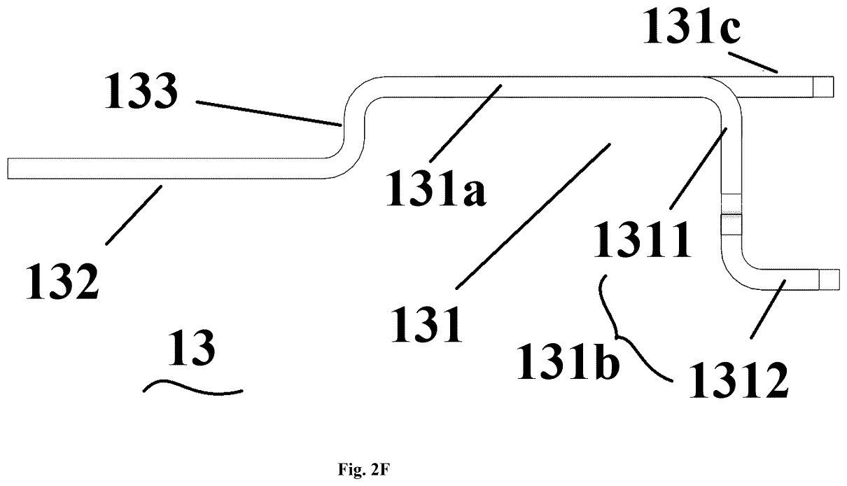

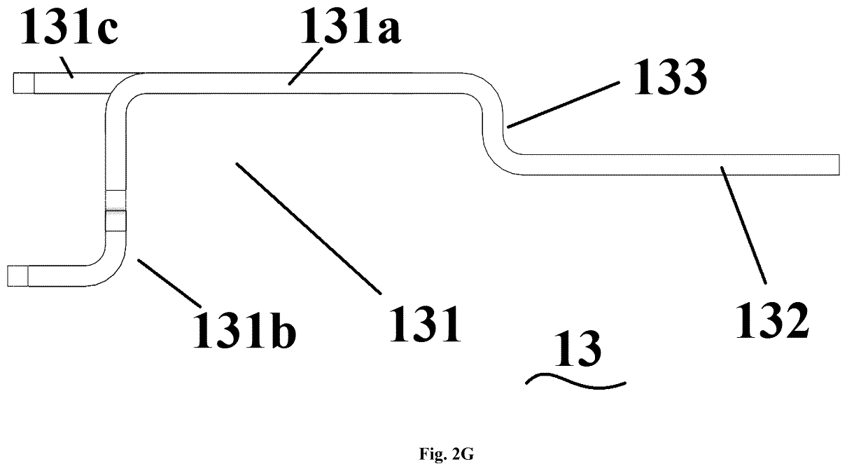

For example as shown in FIGS. 2A-2G, the grounding member 13 extends, for example, in a transverse direction perpendicular to the longitudinal direction, and is positioned at least partially between the two terminal assemblies 12 in a vertical direction orthogonal to both the longitudinal and transverse directions, for example, at least partially positioned between signal terminals 121 of respective at least one set of conductive terminals 120 of the two terminal assemblies 12, to provide further signal shielding for signal terminals 121 in adjacent terminal assemblies 12, thereby being able to improve signal integrity (SI), better meet SI performance requirements such as PCIe Gen6, enabling the electrical connector 1 to adapt to high-speed link data transmission, for example, it can be used as a high-speed input/output connector.

Through this arrangement, by specially designing the shielding structure of the grounding member 13, the coverage area of the shielding region is increased, thereby significantly improving signal integrity against near-end and/or far-end crosstalk (where near-end and far-end are relative to the signal transmission path), promoting effective isolation of interference between signals.

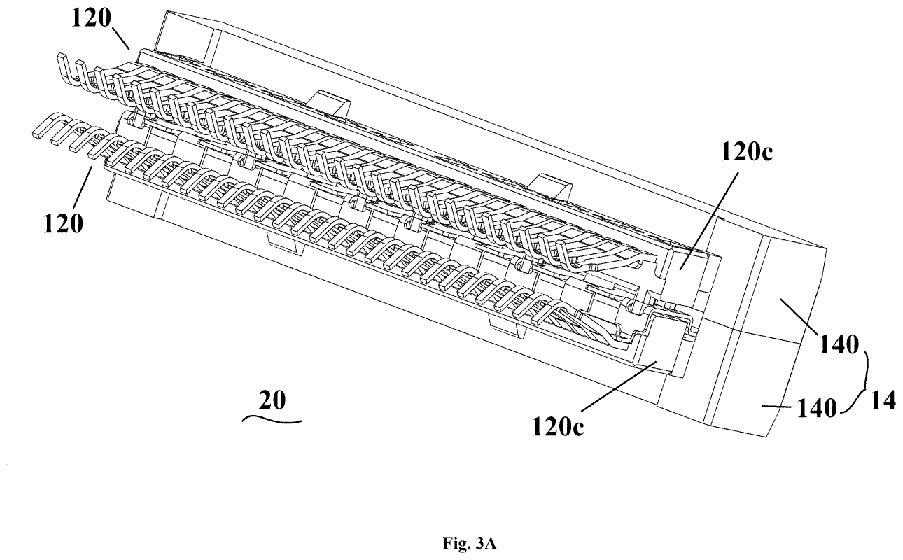

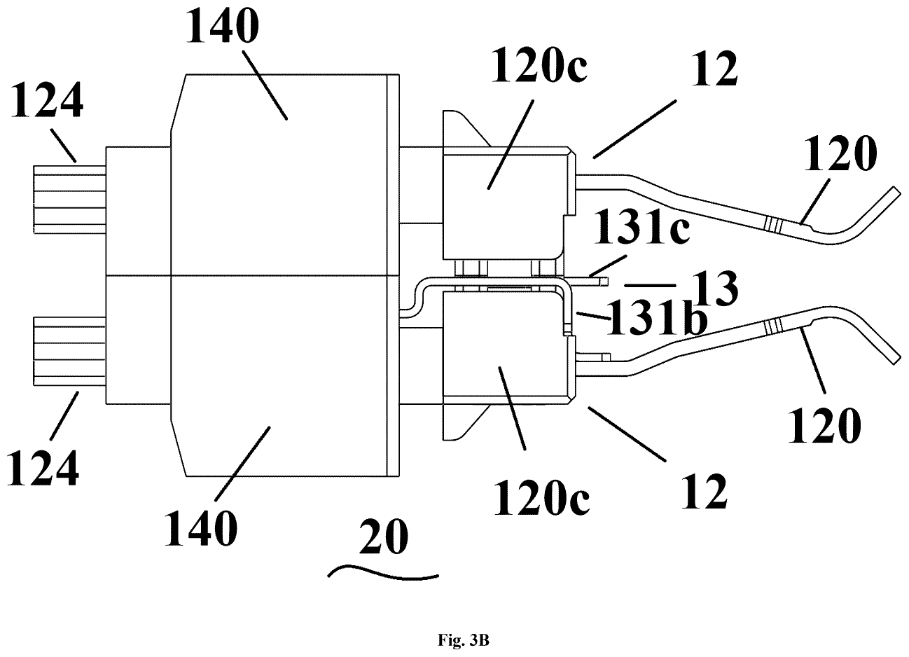

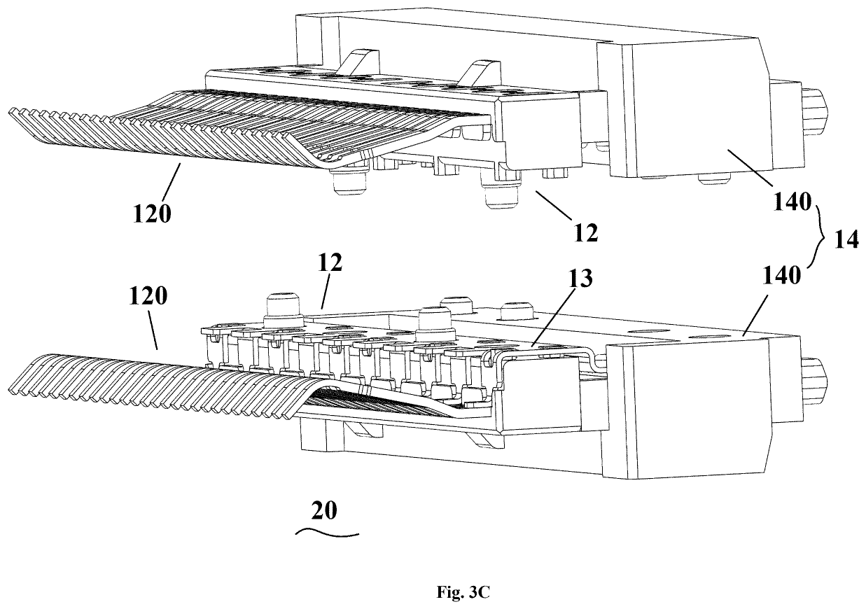

In a further embodiment, as shown, for example, the grounding member 13 is positioned at least between free ends 120a of signal terminals 121 in respective at least one set of conductive terminals 120 of adjacent two terminal assemblies 12 in the vertical direction, as shown in FIGS. 3B and 3C, to at least partially suppress or even completely shield signal interference at the free ends 120a originating from signal terminals 121 in conductive terminals 120 of adjacent terminal assemblies 12 in the vertical direction.

As shown in FIGS. 2A to 2G, the structure of the grounding member 13 (specifically its upstream grounding portion 131) that is conductively connected to one of the two terminal assemblies 12 (e.g., connected to ground terminals 122 in the at least one set of conductive terminals 120 of that terminal assembly for grounding) and integrally shields at least the free ends 120a of respective signal terminals 121 in the at least one set of conductive terminals 120 of that terminal assembly is discussed in detail below, as well as the specific arrangement and electrical connection relationship of the grounding member 13 relative to the at least one set of conductive terminals 120 in the one terminal assembly 12.

According to an exemplary embodiment of the present disclosure, as shown in FIGS. 1A to ID, and FIGS. 2A to 2G, for example, the grounding member 13 comprises an upstream grounding portion 131, the upstream grounding portion 131 being fixed to a respective mounting base 120c of the one terminal assembly 12 and comprising: a body 131a, the body 131a being plate-shaped and extending in a transverse direction perpendicular to the longitudinal direction; a plurality of soldering legs 131b, bent from the body 131a in a vertical direction perpendicular to the longitudinal direction and the transverse direction and abutting against respective ground terminals 122 in the at least one set of conductive terminals 120 of the one terminal assembly 12 to establish a conductive connection; and a plurality of tabs 131c, extending from the body 131a in the longitudinal direction towards the mounting segment 120b, and alternately arranged with the plurality of soldering legs 131b, the plurality of tabs 131c at least partially covering the free ends 120a of respective signal terminals 121 of the one terminal assembly 12. Here, the concepts “upstream” and “downstream” (below) are defined relative to the signal flow direction of the signal path from the free end 120a towards the mounting segment 120b.

Thus, by at least part of the simply constructed grounding member 13 as a single piece, such as the upstream grounding portion 131 described here, the upstream grounding portion 131 can facilitate convenient grounding of respective ground terminals 122 in the at least one set of conductive terminals 120 of the one terminal assembly 12 through the plurality of soldering legs 131b bent in the vertical direction and extending juxtaposed from the body 131a, and can facilitate the upstream grounding portion 131 to at least partially cover the free ends 120a of respective signal terminals 121 of the one terminal assembly 12 using the plurality of tabs 131c alternately arranged with the plurality of soldering legs 131b, for example, completely covering respective signal terminals 121 in the at least one set of conductive terminals 120 of the one terminal assembly 12, thereby achieving reliable grounding and sufficient coverage and interference shielding for all free ends 120a of respective signal terminals 121 in the at least one set of conductive terminals 120 of the one terminal assembly 12 with a simplified structure, saving space, and achieving controllable costs.

First, the signal shielding arrangement at the interface where the free ends 120a of respective ground terminals 122 in the at least one set of conductive terminals 120 of each terminal assembly 12 are grounded to the grounding member 13 (referred to as the upstream mating interface), especially the signal shielding between adjacent conductive terminals 120, is discussed below.

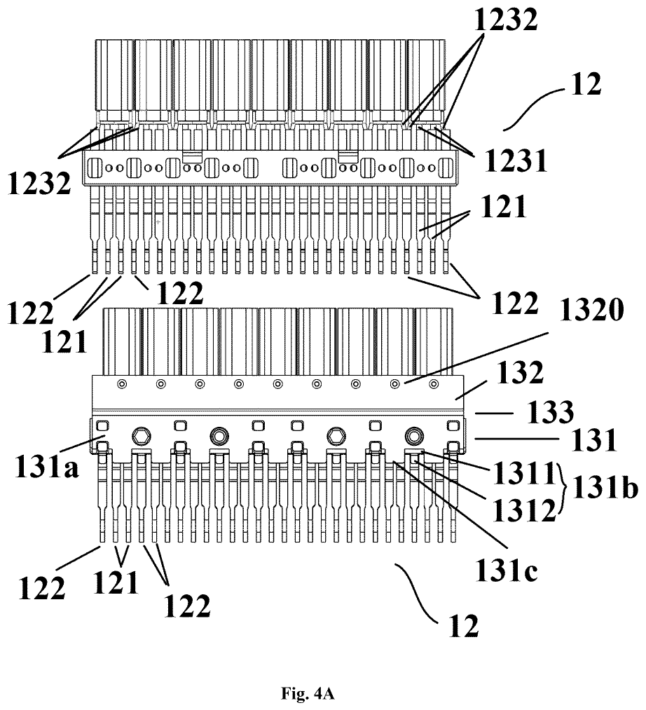

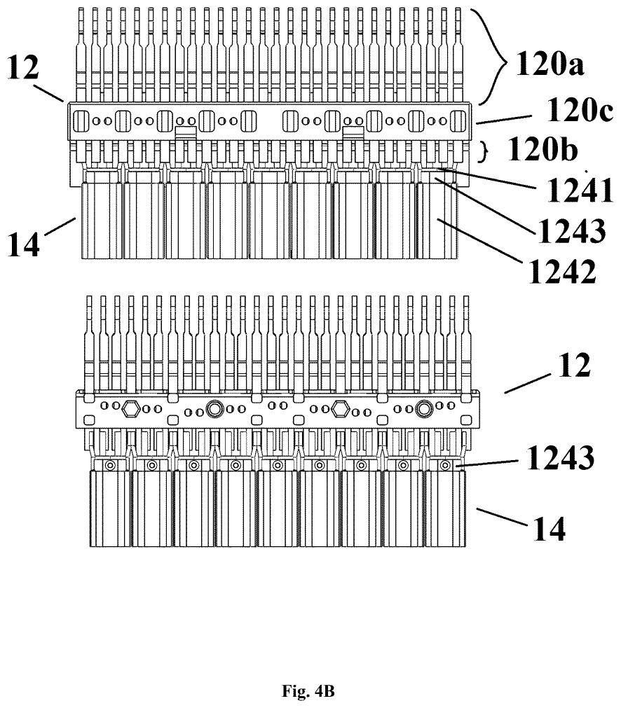

FIGS. 3A to 3C illustrate structural views of internal components within the electrical connector 1, with the housing 11 removed, wherein: FIGS. 3A and 3B respectively illustrate a schematic perspective view and a left side view of the internal components in an assembled state; FIG. 3C illustrates a schematic perspective view of upper and lower internal components in a separated state. And, FIG. 4A illustrates a top view of upper and lower internal components in a separated state with the fixing member and respective mounting bases 120c removed; FIG. 4B illustrates a bottom view of upper and lower internal components in a separated state with the fixing member and respective mounting bases 120c removed.

For example, as shown in FIGS. 4A and 4B, as an example, in each set of conductive terminals 120, the pair of signal terminals 121 and the pair of ground terminals 122 are juxtaposed in the transverse direction and alternately arranged in a one-to-one correspondence, and the two ground terminals 122 in the pair of ground terminals 122 are respectively located on opposite sides of a respective pair of signal terminals 121 in the transverse direction, thus each pair of signal terminals 121 is arranged between two adjacent ground terminals 122 serving as a respective pair of ground terminals 122 to achieve a signal shielding effect between adjacent pairs of signal terminals 121, reducing signal interference.

As a further example, the pair of signal terminals 121 comprises a pair of differential signal terminals 121, the two differential signal terminals 121 in the pair of differential signal terminals 121 being arranged adjacent to each other without a conductive terminal 120 therebetween. This provides signal shielding between pairs of differential signal terminals in the same row. Since differential signals respond to differential-mode signals and are insensitive to common-mode signals, the anti-interference characteristics of differential signals are superior to those of single-ended signals. That is, differential signals respond to the difference between the two carriers, not the difference between a carrier and ground. Even if external interference signals are simultaneously coupled to a pair of differential lines or differential terminals, it can be approximately assumed that the interference coupled to both of the pair is equal in amplitude and in phase, so the differential signal does not respond to it. Also, considering that the currents on the two carriers of a differential signal are opposite, the magnetic fields generated outside the conductors have a certain cancellation effect; and the electric fields are then tightly coupled together, so the radiation interference generated by the differential signal terminals 121 is also less than that of single-ended signal terminals 121.

Next, the specific settings for achieving grounding and improved signal shielding through the more specific construction of the upstream grounding portion 131 of the grounding member 13 are discussed in detail.

In an exemplary embodiment of the present disclosure, the grounding member 13 is made, for example, of various conductive materials (typically such as metal or alloy materials), and can be grounded in various ways, for example, the grounding member 13 can be electrically connected directly or indirectly to ground terminals 122, or to grounding components on electrical equipment or its circuit board, to establish a grounding electrical connection therebetween.

In the embodiment shown in FIGS. 2A to 2G, each soldering leg 131b has an L-shaped longitudinal cross-section and comprises: a base portion 1311, bent from the body 131a towards the vertical direction and formed with an opening for receiving a respective protrusion; and a contact arm 1312, formed as a planar tab extending from the base portion 1311 in the longitudinal direction and adapted to be in conductive contact with the respective ground terminal 122. Thus, a grounding connection is established at the interface where conductive contact is made between the contact arm 1312 of each soldering leg 131b and the free end 120a of the respective ground terminal 122 (i.e., the interface where the respective contact arms 1312 of the plurality of soldering legs 131b are conductively connected to respective ground terminals 122 in the at least one set of conductive terminals 120 of the one terminal assembly 12 to achieve grounding, this mating interface being implemented, for example, by soldering between the contact portion and the respective ground terminal 122).

In a further specific embodiment, for example referring back to FIGS. 3A to 3C, the tabs 131c extend in the longitudinal direction to the interface where the plurality of soldering legs 131b are conductively connected to the free ends 120a of respective ground terminals 122 in the at least one set of conductive terminals 120 of the one terminal assembly 12, and are located directly above the free ends 120a of respective signal terminals 121 in the at least one set of conductive terminals 120, for example to thereby shield signal interference from the free ends 120a of signal terminals 121 in conductive terminals 120 of the other terminal assembly 12 above the tabs 131c, thereby achieving at least partial suppression or even complete shielding of signal interference at the free ends 120a originating from signal terminals 121 in conductive terminals 120 of adjacent terminal assemblies 12 in the vertical direction, and also at least partially suppressing or even completely shielding radiation interference generated outwardly by signal terminals 121 in the conductive terminals 120 of this terminal assembly 12 at the free ends 120a.

The electrical connection relationship between the mounting segments 120b of the signal terminals 121 in the at least one set of conductive terminals 120 of each terminal assembly 12 and the at least one cable 124, the bonding relationship between the grounding member 13 and the at least one cable 124, and the signal shielding arrangement at that location (referred to as the downstream mating interface) are discussed in detail below.

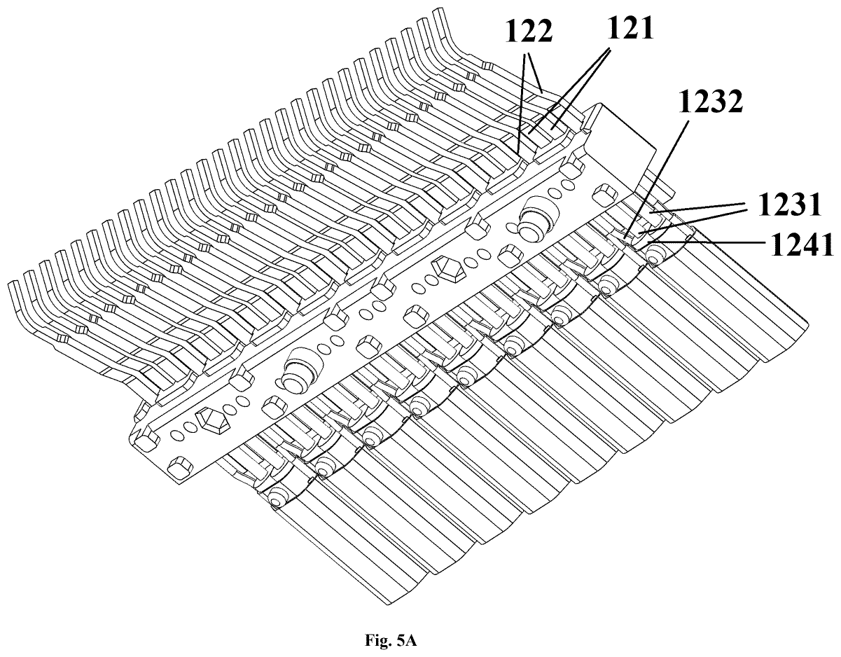

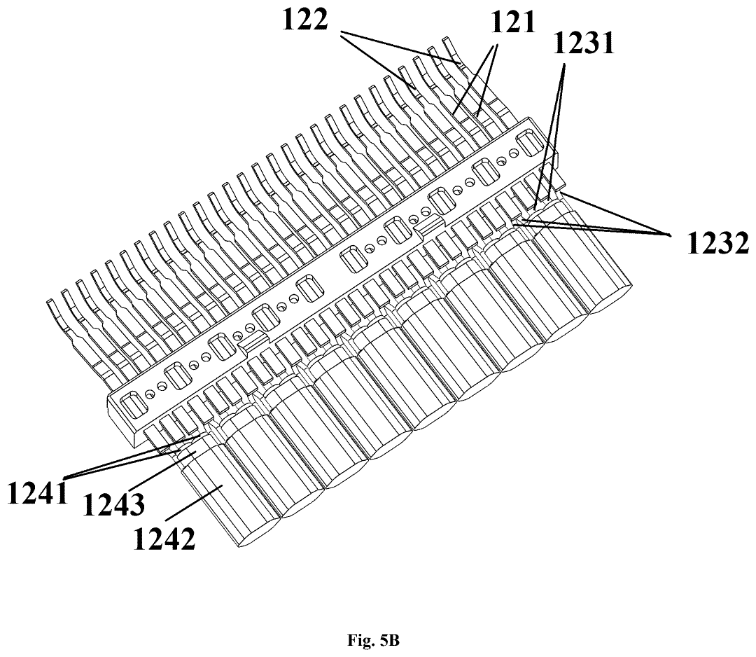

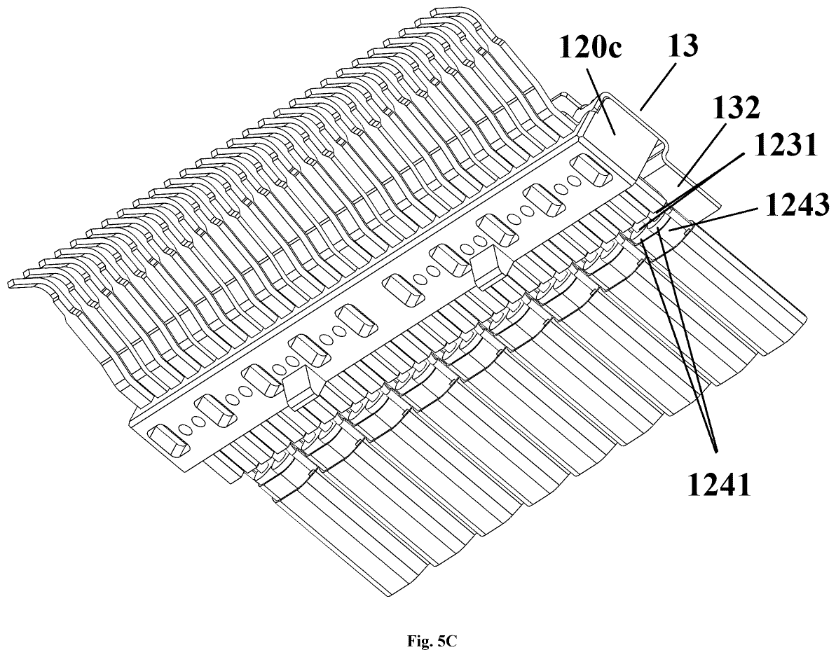

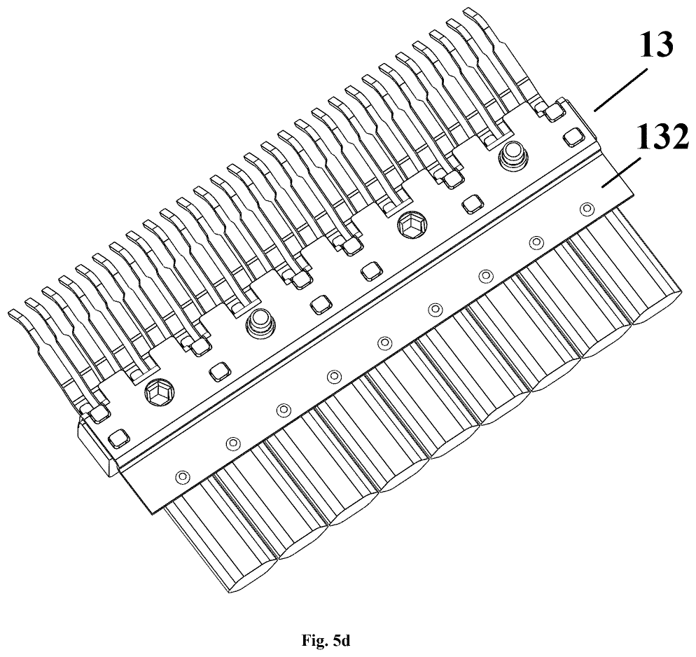

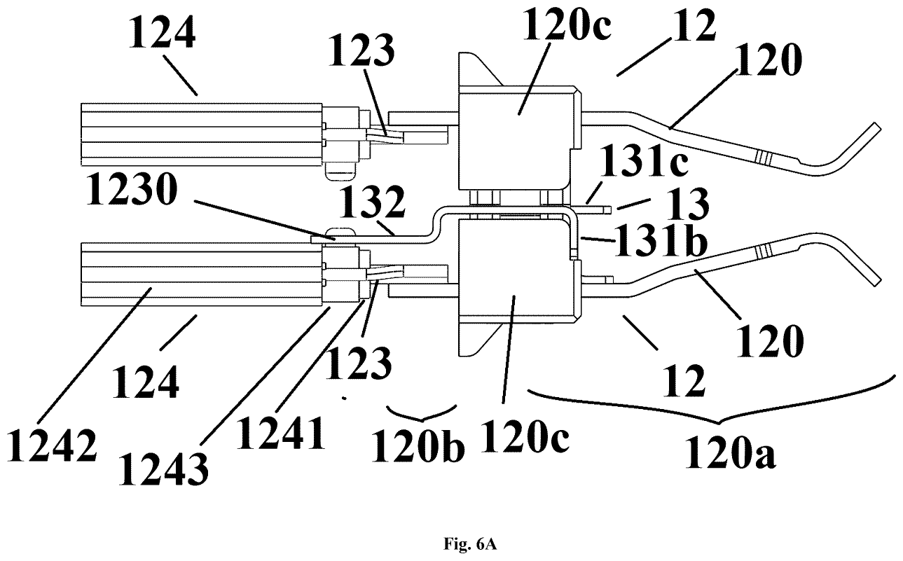

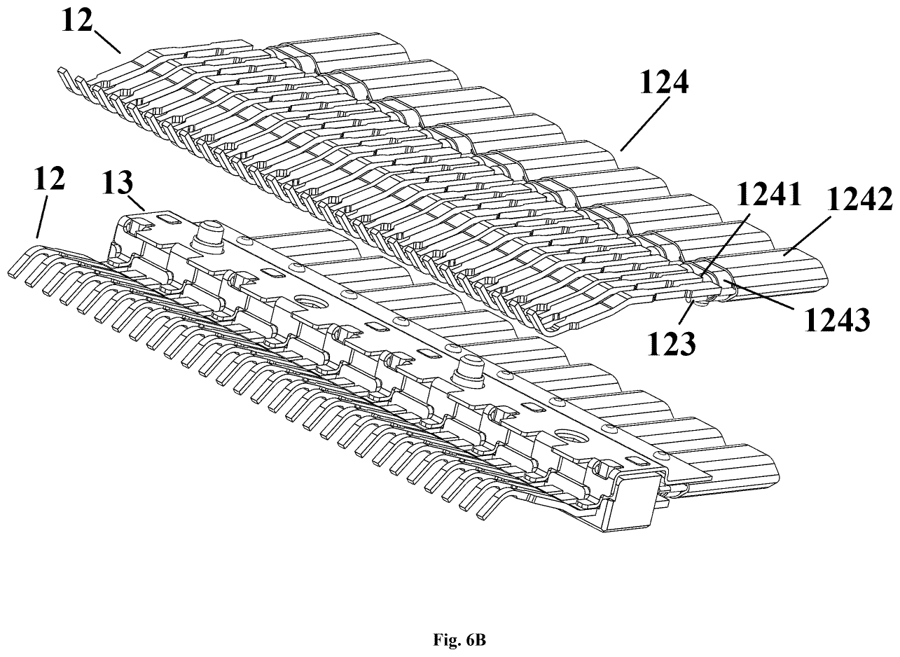

FIGS. 5A and 5B respectively illustrate schematic perspective views of an upper internal component with the respective fixing part 140 of the fixing member and the respective mounting base 120c removed from different viewing angles; and FIGS. 5C and 5D respectively illustrate schematic perspective views of a lower internal component with the respective fixing part 140 of the fixing member and the respective mounting base 120c removed from different viewing angles. FIG. 6A illustrates a left side view of the internal components in an assembled state with the fixing member removed; and FIG. 6B illustrates a schematic perspective view of upper and lower internal components in a separated state with the fixing member removed.

According to an exemplary embodiment of the present disclosure, as shown in FIGS. 5A to 5D, as an example, each terminal assembly 12 further comprises at least one set of wires 123 respectively electrically connected to the at least one set of conductive terminals 120, each set of wires 123 comprising a pair of signal wires 1231 and a pair of ground wires 1232, the two signal wires 1231 in the pair of signal wires 1231 being juxtaposed in the transverse direction and respectively conductively connected to mounting segments 120b of a respective pair of signal terminals 121; and the two ground wires 1232 in the pair of ground wires 1232 being respectively located on opposite sides of the pair of signal wires 1231 in the transverse direction.

In a further embodiment, as shown in FIGS. 5A to 5D, as an example, the pair of signal conductors 1241 of each cable 124 are respectively conductively connected to the signal terminals 121 in a respective set of conductive terminals 120 via the signal wires 1231 in a respective set of wires 123.

In a still further embodiment, as shown in FIGS. 6A to 6B, as an example, the pair of signal conductors 1241 are juxtaposed in the transverse direction and sheathed within an aluminum foil shield layer 1243 surrounded by an outer jacket 1242 of the same cable 124, and the pair of ground wires 1232 in the respective set of wires 123 extend to contact an exposed portion of the aluminum foil shield layer 1243 from the outer jacket 1242 of the same cable 124 to establish connection with cable ground.

Thus, through this arrangement at the bonding interface between the grounding member 13 and the at least one cable 124 as the downstream mating interface, specifically, as an intermediary for establishing the conductive connection between the pair of signal conductors 1241 of each cable 124 and the signal terminals 121 in a respective set of conductive terminals 120, the arrangement of the pair of signal wires 1231 and the adjacent pair of ground wires 1232 in the respective set facilitates a signal shielding effect between adjacent pairs of signal wires 1231, reducing signal interference. Furthermore, the arrangement within each cable 124 of its pair of signal conductors 1241 and the pair of ground wires 1232 in the respective set of wires 123 also facilitates improved signal shielding for the pair of signal conductors 1241 to reduce interference with the signals transmitted therein, and suppresses radiation interference generated outwardly by the pair of signal conductors 1241.

Next, the specific settings for achieving grounding and improved signal shielding through the specific construction of the downstream grounding portion 132 of the grounding member 13 are discussed in detail.

In a specific exemplary embodiment of the present disclosure, for example referring back to FIGS. 2A to 2G, as an example, the grounding member 13 further comprises: a downstream grounding portion 132, plate-shaped and suspended relative to a respective mounting base 120c of the one terminal assembly 12 in the longitudinal direction, and extending to at least partially cover mounting segments 120b of signal terminals 121 and ground terminals 122 of a respective set of conductive terminals 120 of the one terminal assembly 12.

In a further specific embodiment, for example see FIGS. 4A to 4B, FIGS. 5A to 5D, and FIGS. 6A to 6B, as an example, the downstream grounding portion 132 is formed with a plurality of through soldering holes 1320, the plurality of soldering holes 1320 being arranged as a row of through holes spaced apart in the transverse direction, and the downstream grounding portion 132 is conductively connected via soldering through the plurality of soldering holes to respective aluminum foil shield layers 1243 surrounded by respective outer jackets 1242 of the plurality of cables 124 to establish connection with cable ground.

In a still further specific embodiment, for example as shown, the downstream grounding portion 132 extends to cover the exposed portion of the aluminum foil shield layer 1243 from a respective outer jacket 1242 of each cable 124.

Through the arrangement at the downstream grounding portion 132 of the grounding member 13 described above, the grounding member 13 partially covers the electrical connection portion between the signal terminals 121 and the cable conductors via the signal wires 1231, and the downstream grounding portion 132 of the grounding member 13 is substantially separated from this electrical connection portion and achieves a substantial electrical connection to the ground terminals 122 via soldering through the soldering holes to the aluminum foil shield layers 1243 in the cables 124 that the ground wires 1232 are conductively connected to, thereby achieving reliable grounding with a simplified structure; and, this not only greatly shields electromagnetic waves radiated outward by the covered signal terminals 121 and signal wires 1231, but also greatly shields electromagnetic waves from the outside world affecting the covered signal terminals 121 and signal wires 1231, effectively improving the signal integrity of the connector. Moreover, by the downstream grounding portion 132 extending to integrally cover the exposed portion of the aluminum foil shield layer 1243 from the respective outer jacket 1242 of each cable 124, it essentially achieves an enlarged signal shielding region, i.e., an increased coverage area of the shielding region, and sufficient coverage and interference shielding for each pair of conductors in the at least one cable 124 and the respective pair of signal wires 1231 conductively connected to the conductors (e.g., the shielding region extends to the downstream mating interface and/or the location where the cable 124 is stripped to expose the metal shield layer), thereby effectively isolating interference between signals.

In an exemplary embodiment according to the present disclosure, further, for example referring back to FIGS. 2A to 2G, the grounding member 13 further comprises a transition portion 133 located between the upstream grounding portion 131 and the downstream grounding portion 132, the transition portion 133 being bent in the vertical direction such that the upstream grounding portion 131 and the downstream grounding portion 132 are arranged in a step-down configuration in the vertical direction. In a further embodiment, for example as shown, the upstream grounding portion 131, the transition portion 133, and the downstream grounding portion 132 are integrally formed as one piece. Such a step-down configuration between the upstream grounding portion 131 and the downstream grounding portion 132 via the transition portion 133 essentially facilitates better conformity to the external contour of the mounting base 120c as the junction between the free end 120a and the mounting segment 120b of the at least one set of conductive terminals 120, to effectively fix the grounding member 13 against the mounting base 120c and between the two terminal assemblies in the vertical direction.

As an example, the upstream grounding portion 131, the transition portion 133, and the downstream grounding portion 132 are formed from a sheet material via sheet metal processing. This achieves the grounding member 13, which is the core component realizing the innovative concept of this application, with a simple manufacturing process; and achieves such improved interference shielding effect and signal integrity with saved space, and at a controllable cost.

In an exemplary embodiment according to the present disclosure, for example referring back to FIGS. 3A to 3C, and FIGS. 6A to 6B, the at least one set of conductive terminals 120 of each terminal assembly 12 extend juxtaposed in the longitudinal direction through a respective mounting base 120c, and the contact segment and the mounting segment 120b of each set of conductive terminals 120 are connected within the mounting base 120c, and respective mounting bases 120c of the two terminal assemblies 12 are provided on surfaces facing each other with respective pluralities of mating portions, the respective pluralities of mating portions of the two terminal assemblies 12 comprising at least one of protrusions and recesses adapted to mate with each other. Through this arrangement, specifically through the mating between the respective pluralities of mating portions on the respective mounting bases 120c of the two terminal assemblies 12, for example, convex-concave shape mating achieves mutual locking, for example in the vertical direction, between the mounting bases 120c of the two terminal assemblies 12.

In a further specific embodiment, for example as shown, the respective mounting bases 120c of the two terminal assemblies 12 are further provided on surfaces facing each other with respective at least one row of pillars, and in a state where the two terminal assemblies 12 are assembled via their respective pluralities of mating portions, the respective at least one row of pillars of the two terminal assemblies 12 are aligned with each other and abut at their tops. Through this arrangement, it facilitates guiding the mating between the two by mutual alignment and abutment of the at least one row of pillars of the two mounting bases 120c, while also achieving effective separation between them to avoid excessive locking caused by over-pressing, making disassembly impossible.

In a still further specific embodiment, for example as shown in FIGS. 3B and 6A, the body 131a of the upstream grounding portion 131 is disposed between respective mounting bases 120c of the two terminal assemblies 12, and the body 131a of the upstream grounding portion 131 of the grounding member 13 is provided with a plurality of first through holes and a plurality of second through holes, the plurality of first through holes being adapted for extension therethrough by a respective at least one row of pillars of a respective mounting base 120c of the one terminal assembly 12, and the plurality of second through holes being adapted for extension therethrough by protrusions in the mating portions of the respective mounting bases 120c of the two terminal assemblies 12. Thus, the body 131a of the upstream grounding portion 131 is fixed to the respective mounting base 120c of the one terminal assembly 12 by the respective at least one row of pillars of the one terminal assembly 12 extending through the first through holes, thereby facilitating the respective mounting bases 120c of the two terminal assemblies 12 to be fixed relative to each other to assemble the respective mating portions of the two terminal assemblies 12 together, and, helping to effectively hold the grounding member 13 between the two mounting bases 120c in the vertical direction and clamp the grounding member 13 tightly between the mating surfaces of the two when the two mounting bases 120c are mated and mutually locked, facilitating firm and detachable clamping fixation of the grounding member 13 between the two mounting bases 120c.

In an exemplary embodiment according to the present disclosure, for example referring back to FIGS. 3A to 3C, a mating space for receiving connection terminals of a mating connector is defined in the vertical direction between respective mounting segments 120b of the at least one set of conductive terminals 120 of each of the two terminal assemblies 12, and the free end 120a of each conductive terminal 120 serves as a contact segment configured to be in conductive contact with the connection terminals of the mating connector.

In an exemplary embodiment according to the present disclosure, for example referring back to FIGS. 1A to ID, at an end of the housing 11 proximate to the free ends 120a of the respective at least one set of conductive terminals 120 of the two terminal assemblies 12, there are formed: two rows of through slots 111, each row extending in the longitudinal direction and spaced apart from each other in the vertical direction, and adapted to respectively accommodate and expose the free ends 120a of the respective at least one set of conductive terminals 120 of the two terminal assemblies; and a row of intermediate holes 112 provided between the two rows of through slots 111, the row of intermediate holes 112 being adapted to receive the plurality of tabs 131c. As a specific example, each row of through slots 111 includes a row of multiple through slots 111 arranged in the transverse direction for the free ends 120a of the at least one set of conductive terminals 120 of the respective terminal assembly to deflect and at least partially insert therein to allow deflection or deformation of the free ends 120a therein, thereby adapting to insertion of conductive terminals 120 of different sizes. And, as an example, the row of intermediate holes 112 is arranged in the transverse direction and is configured, for example, to allow the plurality of tabs 131c of the grounding member 13 to be at least partially inserted therein to be held in place relative to the housing 11.

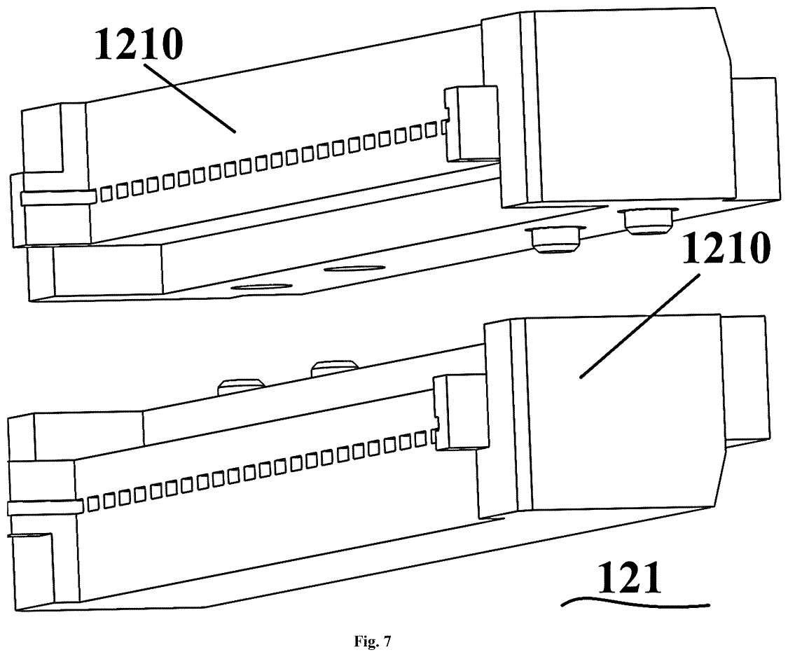

FIG. 7 illustrates a schematic perspective view of the fixing member 14 within the internal components, with a pair of fixing parts 140, shown in FIG. 3C, in a separated state. In an exemplary embodiment according to the present disclosure, for example as shown in FIG. 7, the internal components 20 of the electrical connector 1 further comprise, for example, a fixing member 14, the fixing member 14 being disposed within the housing 11 and comprising a pair of fixing parts 140 mating with each other, each fixing part 140 wrapping the at least one set of wires 123 of a respective terminal assembly 12, and the pair of fixing parts 140 being provided on surfaces facing each other with at least one of protrusions and recesses adapted to mate with each other. Thus, the pair of fixing parts 140 can be connected together in a mating manner to arrange the conductive terminals 120 of the two terminal assemblies 12 respectively fixed to these two fixing parts 140 spaced apart relative to each other within the housing 11.

Based on the electrical connector 1 arranged as described above, the following technical effects compared to existing technical solutions in the field can be achieved. Through the grounding member 13, and the arrangement and assembly relationships of components associated therewith, specifically utilizing the tabs 131c additionally provided on one side in the longitudinal direction of the grounding member 13, alternately arranged with the soldering legs 131b conductively connected to the grounding member 13, to at least partially cover the free ends 120a of the signal terminals 121, and utilizing the extension of the grounding member 13 on the opposite side in the longitudinal direction to integrally cover the electrical connection portion between the signal terminals 121 and the cable conductors via the signal wires 1231, and further extending to cover the exposed portion of the aluminum foil shield layer 1243 from the respective outer jacket 1242 of each cable 124, while the grounding member 13 achieves substantial effective grounding connection to the ground terminals 122 via soldering through its soldering holes to the aluminum foil shield layers 1243 in the cables 124 that the ground wires 1232 are conductively connected to, such specific arrangements thereby achieve a sufficiently increased shielding area of the grounding member 13 also serving as a shielding element to improve isolation of interference between signals; and improve signal integrity, especially against near-end crosstalk and far-end crosstalk.

The above description of the electrical connector 1 in the foregoing embodiments of the present disclosure is intended to be illustrative, not restrictive. Although the present disclosure has been described with reference to the drawings, the embodiments disclosed in the drawings are intended to exemplarily illustrate embodiments of the present disclosure and should not be construed as a limitation of the present disclosure.

Therefore, those skilled in the art will understand that the embodiments described above are exemplary, and those skilled in the art can make improvements. Structures described in various embodiments can be modified and freely combined without conflict in structure or principle. These changes should fall within the protection scope of the present disclosure.

The breadth and scope of the present disclosure should not be limited by any of the above-described exemplary embodiments, but should be defined only in accordance with the following claims and their equivalents.

The wording “comprising” does not exclude other components or steps, and the wording “a/an” or “one” does not exclude multiple or a plurality of. Furthermore, any reference numeral(s) in the claims should not be construed to be limitation of the scope of the present disclosure.

1. An electrical connector, comprising:
a housing;
a pair of terminal assemblies adjacent to each other and juxtaposed within the housing, each of the terminal assemblies includes:
at least one set of conductive terminals extending parallel to a longitudinal direction of the housing, each set of conductive terminals having a pair of signal terminals and a pair of ground terminals;
at least one cable, each cable having a pair of signal conductors respectively conductively connected to the signal terminals in a respective set of conductive terminals; and
a mounting base, the at least one set of conductive terminals passing through the mounting base and being divided by the mounting base into a mounting segment on a side facing the at least one cable and a free end on an opposite side; and
a grounding member conductively connected to respective ground terminals of one terminal assembly and integrally covering respective signal terminals of the one terminal assembly.

2. The electrical connector of claim 1, wherein the grounding member has an upstream grounding portion, the upstream grounding portion is fixed to the mounting base of the one terminal assembly and includes:
a body that is plate-shaped and extends in a transverse direction perpendicular to the longitudinal direction;
a plurality of soldering legs bent from the body in a vertical direction perpendicular to both the longitudinal direction and the transverse direction, and abutting against respective ground terminals in the at least one set of conductive terminals of the one terminal assembly to establish a conductive connection; and
a plurality of tabs extending from the body in the longitudinal direction towards the mounting segment and alternately arranged with the plurality of soldering legs, the plurality of tabs cover a plurality of free ends of the signal terminals of the one terminal assembly.

3. The electrical connector according to claim 2, wherein, in each set of conductive terminals, the pair of signal terminals and the pair of ground terminals are juxtaposed in the transverse direction and alternately arranged in a one-to-one correspondence, and the two ground terminals in the pair of ground terminals are respectively located on opposite sides of the pair of signal terminals in the transverse direction.

4. The electrical connector according to claim 3, wherein the pair of signal terminals include a pair of differential signal terminals, the differential signal terminals in the pair of differential signal terminals are arranged adjacent to each other without a conductive terminal therebetween.

5. The electrical connector according to claim 2, wherein each soldering leg has an L-shaped longitudinal cross-section and includes:
a base portion bent from the body towards the vertical direction and formed with an opening for receiving a respective protrusion; and
a contact arm formed as a planar tab extending from the base portion in the longitudinal direction and adapted to be in conductive contact with one of the ground terminals.

6. The electrical connector according to claim 5, wherein the tabs extend in the longitudinal direction to an interface where the plurality of soldering legs are conductively connected to a plurality of free ends of the ground terminals in the at least one set of conductive terminals of the one terminal assembly, the tabs are located directly above the free ends of the signal terminals in the at least one set of conductive terminals.

7. The electrical connector according to claim 2, wherein each terminal assembly further comprises at least one set of wires respectively electrically connected to the at least one set of conductive terminals, each set of wires includes a pair of signal wires and a pair of ground wires, the two signal wires in the pair of signal wires are juxtaposed in the transverse direction and respectively conductively connected to the mounting segments of the pair of signal terminals, the two ground wires in the pair of ground wires are respectively located on opposite sides of the pair of signal wires in the transverse direction.

8. The electrical connector according to claim 7, wherein the pair of signal conductors of each cable are respectively conductively connected to the signal terminals in a respective set of conductive terminals via the signal wires in a respective set of wires.

9. The electrical connector according to claim 8, wherein the pair of signal conductors are juxtaposed in the transverse direction and sheathed within an aluminum foil shield layer surrounded by an outer jacket of the cable, and the pair of ground wires in the respective set of wires extend to contact an exposed portion of the aluminum foil shield layer from the outer jacket of the cable to establish connection with cable ground.

10. The electrical connector according to claim 2, wherein the grounding member includes a downstream grounding portion that is plate-shaped and suspended relative to the mounting base of the one terminal assembly in the longitudinal direction, and extending to at least partially cover the mounting segments of the signal terminals and the ground terminals of the at least one set of conductive terminals of the one terminal assembly.

11. The electrical connector according to claim 10, wherein the downstream grounding portion has a plurality of soldering holes passing therethrough, the plurality of soldering holes are arranged as a row of through holes spaced apart in the transverse direction, and the downstream grounding portion is conductively connected via soldering through the plurality of soldering holes to an aluminum foil shield layer surrounded by a plurality of outer jackets of a plurality of cables to establish connection with cable ground.

12. The electrical connector according to claim 11, wherein the downstream grounding portion extends to cover an exposed portion of the aluminum foil shield layer that is exposed from a respective outer jacket of each cable.

13. The electrical connector according to claim 10, wherein the grounding member includes a transition portion located between the upstream grounding portion and the downstream grounding portion, the transition portion is bent in the vertical direction such that the upstream grounding portion and the downstream grounding portion are arranged in a step-down configuration in the vertical direction, and the upstream grounding portion, the transition portion, and the downstream grounding portion are integrally formed as one piece.

14. The electrical connector according to claim 13, wherein the upstream grounding portion, the transition portion, and the downstream grounding portion are formed from a sheet material via sheet metal processing.

15. The electrical connector according to claim 2, wherein the at least one set of conductive terminals of each terminal assembly extend juxtaposed in the longitudinal direction through the mounting base, and a contact segment and the mounting segment of each set of conductive terminals are connected within the mounting base, and respective mounting bases of the pair of terminal assemblies are provided, on surfaces facing each other, with respective pluralities of mating portions, the respective pluralities of mating portions of the two terminal assemblies comprising at least one of protrusions and recesses adapted to mate with each other.

16. The electrical connector according to claim 15, wherein the respective mounting bases of the pair of terminal assemblies are further provided, on surfaces facing each other, with respective at least one row of pillars, and in a state where the pair of terminal assemblies are assembled via their respective pluralities of mating portions, the respective at least one row of pillars of the pair of terminal assemblies are aligned with each other and abut.

17. The electrical connector according to claim 16, wherein the body of the upstream grounding portion is disposed between respective mounting bases of the two terminal assemblies, and the body has a plurality of first through holes and a plurality of second through holes, the plurality of first through holes receive a respective at least one row of pillars of a respective mounting base of the one terminal assembly, and the plurality of second through holes receive the protrusions in the mating portions of the respective mounting bases of the two terminal assemblies.

18. The electrical connector according to claim 2, wherein a mating space for receiving connection terminals of a mating connector is defined in the vertical direction between respective mounting segments of the at least one set of conductive terminals of each of the two terminal assemblies, and the free end of each conductive terminal serves as a contact segment configured to be in conductive contact with the connection terminals of the mating connector.

19. The electrical connector according to claim 6, wherein, at an end of the housing proximate to a plurality of free ends of the respective at least one set of conductive terminals of the pair of terminal assemblies, there are formed:
a pair of rows of through slots, each row extending in the longitudinal direction and spaced apart from each other in the vertical direction, and adapted to respectively accommodate and expose the free ends of the respective at least one set of conductive terminals of the two terminal assemblies; and
a row of intermediate holes provided between the pair of rows of through slots, the row of intermediate holes receives the plurality of tabs.

20. The electrical connector according to claim 7, further comprising a fixing member disposed within the housing and having a pair of fixing parts mating with each other, each fixing part wrapping the at least one set of wires of a respective terminal assembly, the pair of fixing parts being provided on surfaces facing each other with at least one of protrusions and recesses adapted to mate with each other.
